(19) United States
(12) Patent Application Publication
(10) Pub. No.: US 2006/0157980 A1
(43) Pub. Date: Jul. 20, 2006

(54) Dual material threading for pipe adapter

(75) Inventor: Bernard Lee Thompson, Huntsville, AL (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: CRIMSON TIDE, LLC, Charlotte, NC (US)

(21) Appl. No.: 11/375,620

(22) Filed: Mar. 13, 2006

Related U.S. Application Data
(63) Continuation of application No. 10/425,482, filed on Apr. 29, 2003.
Application No. 10/425,482 is a continuation-in-part of application No. 10/234,683, filed on Sep. 4, 2002, now abandoned.
Application No. 10/234,683 is a continuation-in-part of application No. 10/084,101, filed on Feb. 27, 2002, now abandoned.

(51) Int. Cl. F16L 25/00; F16L 35/00

(52) U.S. Cl. 285/330

(57) ABSTRACT

An adapter for connecting two segments of pipe is disclosed. The adapter includes a guide insert made of a rigid material and a receptor body made of a plastic material. Both the guide insert and the receptor body have threads that fit together so that a threaded pipe segment is first inserted into the rigid threads of the guide insert and then transitions to the plastic threads of the receptor body.

### CROSS-REFERENCE TO RELATED APPLICATIONS

This application is a continuation of U.S. patent application Ser. No. 10/425,482, filed on Apr. 29, 2003, which is a continuation-in-part of U.S. patent application Ser. No. 10/234,683 that was filed on Sep. 4, 2002 (now abandoned), which is a continuation-in-part of U.S. patent application Ser. No. 10/084,101 that was filed on Feb. 27, 2002 (now abandoned).

### BACKGROUND OF INVENTION

1. Field of the Invention

The invention relates generally to fluid pipe connections. More particularly, the invention relates to a pipe adapter with a dual material threading.

2. Background Art

It is increasingly common for commercial and residential plumbing lines to be made of a plastic material such as chlorinated polyvinyl chloride (CPVC). CPVC offers the advantages of cost, weight, and ease of handling and installation as compared with more traditional metal pipes. Additionally, CPVC is not subject to corrosion like the metal materials. However, CPVC generally lacks the durability of metal, especially when used for components that are exposed to various stresses during installation. A CPVC adapter that serves to join a CPVC pipe segment to another threaded male pipe segment is particularly susceptible to damage during installation. For example, if a threaded male portion of the pipe is screwed too far into the corresponding female portion of a CPVC adapter, the female portion may rupture outward or split laterally from excessive internal stress called “hoop stress”.

The threaded portion of a CPVC adapter is also potentially subject to misalignment or “cross-threading” due the relative pliability of CPVC as compared with metal. This is especially true if a threaded male pipe that is made of metal is inserted into a threaded female receptor that is made of CPVC. If both sets of threads are not properly aligned as the segments join together, the metal threads may cut across the CPVC-threads because the metal is more rigid than the CPVC. This results in damage to the CPVC receptor and it may be severe enough to prevent a proper seal between the pipe and the adapter.

A prior art solution is to use an adapter made of a durable metal such as brass. FIG. 1a shows a cross sectional view of a prior art brass adapter 10 for a plastic CPVC pipe. FIG. 1b shows an exploded cross sectional view of the prior art adapter 10 shown in FIG. 1a. The prior art adapter 10 has two components: a tapered threaded brass female receptor 12; and a smooth CPVC female receptor socket 14. The brass receptor 12 connects to a tapered threaded male connection of a component pipe (not shown). The exterior surfaces of the brass adapter 16 form a hexagonal shaped nut that is used to tighten the adapter onto the pipe. The threaded male connection will be inserted until it fits up against an annular ledge 20 in the interior of the brass receptor 12. Since the threads 15 are tapered inward, the threaded male connection forms a seal against the brass receptor as it is tightened. The CPVC receptor socket 14 has a smooth interior 18 that allows the receptor 14 to be glued to a male segment of plastic CPVC pipe (not shown). The male CPVC pipe segment will be inserted until it fits up against an annular ledge 22 in the interior 18 of the CPVC receptor 14 and glued in place.

Once the adapter 10 joins the pipe segments together, an interior fluidway 24 is formed that allows fluid to pass though the adapter 10. However, a segment 26 of the brass receptor 12 is exposed to the fluid. This brass segment 26 may begin to corrode through a process known as “de-zincification”. De-zincification selectively removes zinc from an alloy such a brass. Since brass is an alloy made of copper and zinc, eventually all that is left is a porous, copper rich material that has little mechanical strength. This weakened adapter may eventually fail. While de-zincification affects brass and other zinc alloys, other types of metal adapters may also be corroded by aggressive fluids. In the case of potable (i.e., drinkable) water, such corrosion may cause an additional concern of heavy metal contamination from the corroded metal adapter. Heavy metal contamination is a particular concern if lead is a component in the alloy. An alloy containing lead may leach out the lead and contaminate the water that flows through the adapter. Lead poisoning may result if a person consumes the contaminated water.

### SUMMARY OF INVENTION

In some aspects, the invention relates to an apparatus to connect two segments of pipe, comprising: a threaded rigid guide insert that connects with a first threaded pipe segment; a threaded plastic receptor that connects with a second pipe segment, where the plastic receptor is joined with the rigid guide insert to form a fluidway between the first and second pipe segments; and where the threads of the rigid guide insert and the threads of the plastic receptor fit together to form a threaded connection for the first threaded pipe segment

In other aspects, the invention relates to an adapter for joining two pipe segments, comprising: means for connecting a first threaded pipe segment and second pipe segment using a durable material; and means for ensuring proper alignment of the first pipe segment.

Advantages of the invention include: providing a guide for a threaded male pipe segment to resist cross-threading across plastic threads; and providing a protected fluidway through the adapter that protects the adapter from corrosion and also protects the contents of the fluidway from contamination.

Other aspects and advantages of the invention will be apparent from the following description and the appended claims.

### BRIEF DESCRIPTION OF DRAWINGS

It should be noted that identical features in different drawings are shown with the same reference numeral.

FIG. 1a shows a cross sectional view of a prior art brass adapter for plastic pipe.

FIG. 1b shows an exploded cross sectional view of the prior art adapter as shown in FIG. 1a.

FIG. 2a shows a cross sectional view of a rigid adapter.

FIG. 2b shows an exploded cross sectional view of the rigid adapter as shown in FIG. 2a.

FIG. 3 shows a cross sectional view of a recessed annular ledge connection.

FIG. 4a shows a side view of a sprinkler-head adapter.

FIG. 4b shows a frontal view of a sprinkler-head adapter.

FIG. 5 shows a cross sectional view of a sprinkler-head adapter.

FIG. 6a shows a side view of a sprinkler-head and a sprinkler-head adapter.

FIG. 6b shows a cross sectional view of a sprinkler-head and a sprinkler-head adapter.

FIG. 7a shows a side view of a smooth insert.

FIG. 7b shows a side view of an insert with a knurled middle segment.

FIG. 7c shows a side view of an insert with three octagonal shaped segments.

FIG. 8a shows an exploded view of an adapter with dual material threads in accordance with one embodiment of the present invention.

FIG. 8b shows a cross section view of an adapter with dual material threads in accordance with one embodiment of the present invention.

FIG. 8c shows a frontal view of an adapter with dual material threads in accordance with one embodiment of the present invention.

FIG. 9a shows an exploded view of a sprinkler-head adapter with dual material threads in accordance with one embodiment of the present invention.

FIG. 9b shows a cross section view of a sprinkler-head adapter with dual material threads in accordance with one embodiment of the present invention.

FIG. 9c shows a frontal view of a sprinkler-head adapter with dual material threads in accordance with one embodiment of the present invention.

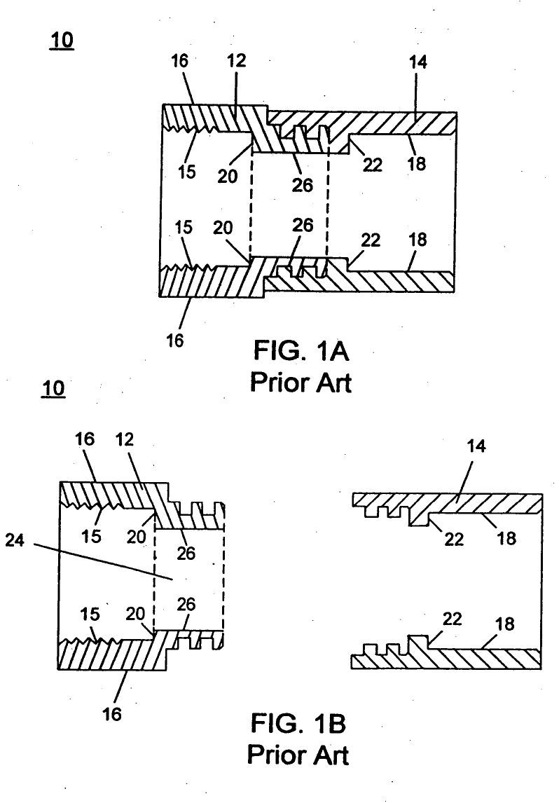

### DETAILED DESCRIPTION

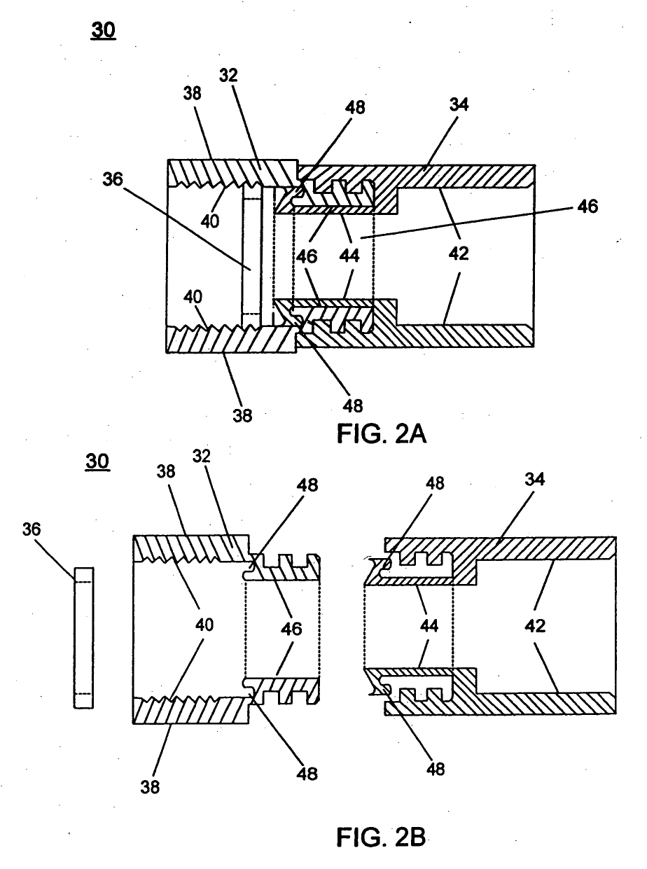

FIG. 2a shows a cross sectional view of a rigid adapter 30. FIG. 2b shows an exploded cross sectional view of a rigid adapter 30 as shown in FIG. 2a. The adapter 30 includes three components: a threaded brass female receptor 32; a smooth CPVC female receptor socket 34; and a sealing gasket 36. The threaded brass receptor 32 provides suitable durability for the adapter to withstand normal stresses during installation. In alternative embodiments, the receptor may be made of alternative durable, rigid materials such as other metals, alloys or rigid plastics in various combinations that are known in the art. For example, the term “brass” is generally understood to mean an alloy of copper and zinc. However, it is common for other elements such as aluminum, iron, manganese, nickel, tin, and lead to be added to the alloy. Additionally, the percentages of each material in the alloy will vary widely as dictated by the performance needs of a specific application. The CPVC receptor socket 34 is made of chlorinated polyvinyl chloride (CPVC). In alternative embodiments, the receptor may be made of other suitable plastic materials such as polyvinyl chloride (PVC), other vinyls, or any other suitable materials that are known in the art. As such, the term “plastics” is intended to encompassing materials of different strengths and flexibilities. Typically, plastics can be categorized as: rigid; semi-rigid; and flexible. The sealing gasket 36 is made of a squeezable or compressible material such as: rubber; a rubber/plasticizer compound; various elastomers; or other suitable materials known in the art.

The brass receptor 32 is designed to join the adapter 30 to a threaded male end of a pipe segment (not shown). The receptor 32 has flat exterior surfaces 38 that form a hexagonal shaped nut. The receptor 32 is rotated by applying torque to the exterior surfaces 38 so that the pipe segment is screwed into the threads 40 of the receptor 32. In alternative embodiments, other shapes and configurations of the exterior surface of the adapter could be used. For example, a generally circular shaped fastener or any other suitable arrangement that would provide a durable surface for applying torque to the adapter could be used. The threaded male pipe segment is tightened until it reaches the sealing gasket 36. The gasket 36 is squeezed until it creates a seal between the CPVC receptor socket 34 and the threaded male pipe segment. In the embodiment shown, the threads 40 of the brass receptor are straight instead of tapered. A seal is created by the gasket 36 instead of the threads. However, in alternative embodiments, the threads could be tapered inward to provide an additional sealing mechanism. The gasket 36 prevents the pipe segment for being inserted too far into the receptor 32 and potentially damaging the pipe segment or creating excessive hoop stress.

Additionally, no filler material such as “pipe dope” or “pipe tape” is necessary to ensure a seal at the threads 40.

The CPVC receptor socket 34 has a smooth interior 42 that receives a smooth male CPVC plastic pipe segment (not shown). The male pipe segment is inserted into the receptor socket 34 and glued in place to make a seal. The receptor socket 34 and the smooth male pipe segment should be made of the same material in order to facilitate a proper seal. The receptor 34 includes an interior CPVC protective insert layer 44. The protective insert layer 44 is formed to protect a segment 46 of the brass receptor 32 from exposure to the fluidway 46. Since the CPVC receptor 34 and its protective layer 44 are made of a non-corroding material, it prevents corrosion of the threaded receptor 32.

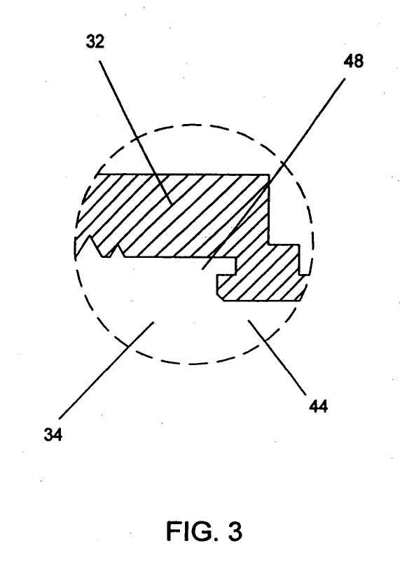

The protective insert layer 44 is fixed to the threaded receptor 32 with a recessed annular ledge 48. FIG. 3 shows a cross sectional view of a recessed annular ledge connection. The recessed annular ledge 48 is formed in the interior of the brass receptor 32. The protective insert layer 44 of the plastic receptor socket 34 fully covers and extends into the recessed ledge 48 by “hooking” into the ledge 48. When the sealing gasket 36 (referring back to FIGS. 2a and 2b) is fully compressed against the protective insert layer 44, the brass receptor 32 is fully insulated from contact with the contents of the fluidway 46. Any material in the fluidway only contacts the interior of the threaded male pipe segment, the sealing gasket 36, the protective insert layer 44 of the CPVC receptor 34 and the interior of the smooth male plastic pipe segment. Consequently, the brass receptor 32 is protected and not exposed to any corrosive materials in the fluidway 46.

In some alternative embodiments, the adapter and its fluidway are designed to carry water in a commercial or residential plumbing application. In other embodiments, the water to be carried is potable (i.e., drinkable) water. In alternative embodiments, the diameter size of the adapter will vary. The adapter may be sized to fit common sized pipes including: ½ inch; ¾ inch; and 1 inch diameter pipes. The adapter may also be designed to fit common metric sized diameter pipes and copper tube sizes (CTS).

In some alternative embodiments, the form, pitch, and taper of the threads of the adapter conform to American National. Standards Institute (ANSI) B2.1. In other embodiments, the pitch diameter of the threads is enlarged slightly (approximately 0.015 inches) to allow mating parts to screw in far enough to compress the sealing gasket at the base of the threads. The increased pitch diameter allows sufficient mechanical engagement to prevent pull-out.

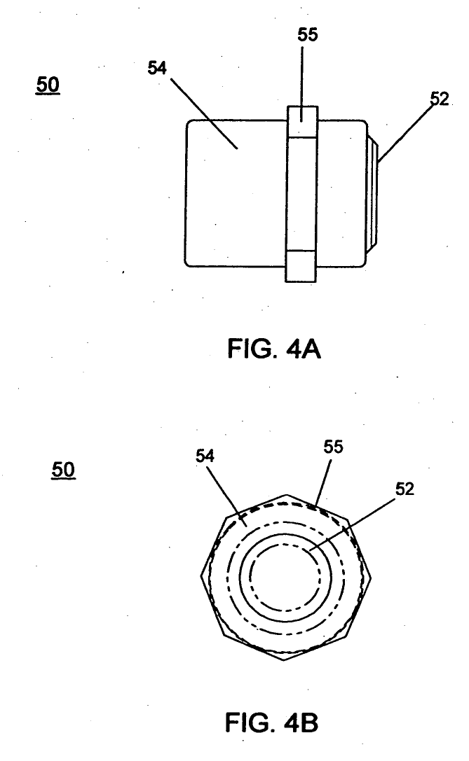

FIG. 4a shows a side view of a sprinkler-head adapter with a protected fluidway 50, while FIG. 4b shows a frontal view of the same adapter 50. In this embodiment, the brass insert 52 is more substantially encased in the CPVC receptor 54 than was shown previously for the connector in FIGS. 2a and 2b. Raised surfaces on the exterior of the receptor form a hexagonal shaped nut 55. The nut 55 is used to grip the adapter 50 while tightening the sprinkler-head (not shown) into the insert 52.

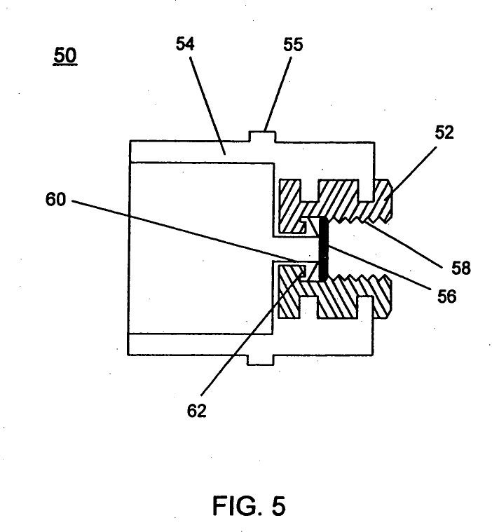

FIG. 5 shows a cross sectional view of the sprinkler-head adapter 50. The brass insert 52 is embedded in the CPVC receptor 54. In a similar approach that was previously shown in FIGS. 2a, 2b, the CPVC receptor 54 forms a protective layer 60 that covers the interior of the brass insert 52 and prevents exposure of the insert 52 to the contents of the fluidway. The protective layer 60 is hooked into the insert by a recessed ledge 62 as shown previously in FIG. 3. A flexible gasket 56 is used to provide a seal between the adapter 50 and a sprinkler-head (not shown). In this embodiment, the threads 58 on the interior of the insert 52 are straight. However, alternative embodiments could vary the type, size, pitch and taper of the threads.

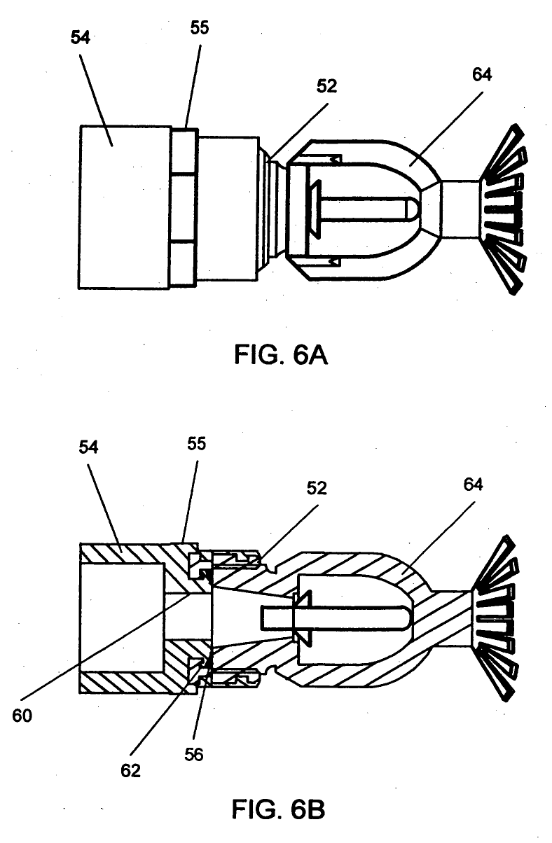

FIG. 6a shows a side view of a sprinkler-head and a sprinkler-head adapter. FIG. 6b shows a cross-sectional view of the same embodiment. Both figures show the adapter with a sprinkler-head 64 connected to the insert 52. The sprinkler-head 64 is a standard apparatus that is widely used in piping systems for tasks such as fire suppression. FIG. 6b shows the sprinkler-head 64 screwed into the insert 52 to the point where the flexible gasket 56 is compressed between the CPVC receptor 54 and the sprinkler-head 64 to form a seal. The result is a brass insert 52 that is insulated from contacting the contents of the fluidway by a protective layer 60 that extends from the CPVC receptor 54. It should be clear that alternative embodiments using previously described materials, component sizes, and configurations for the connector shown in FIGS. 2a and 2b are applicable to the sprinkler-head adapter as well.

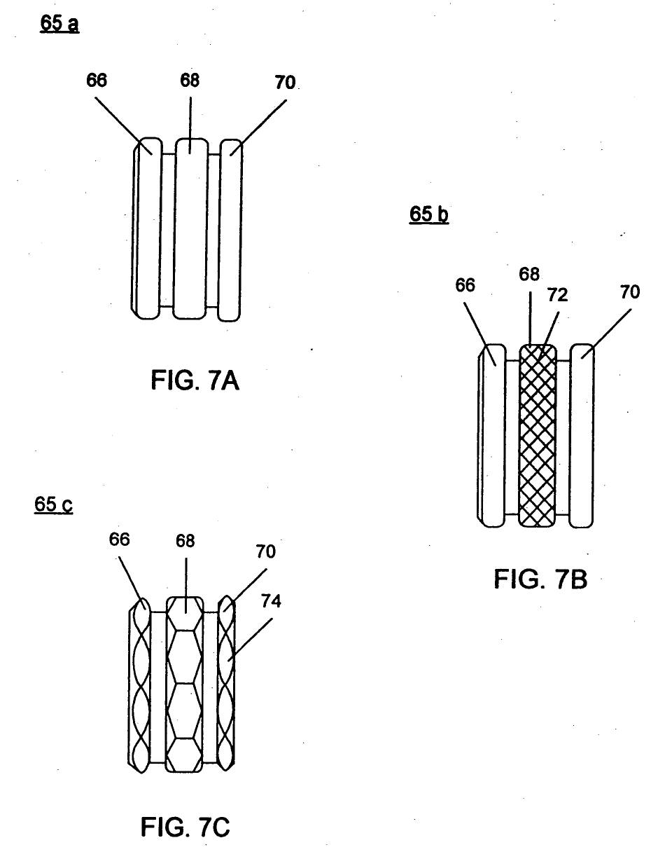

FIGS. 7a-7c show alternative embodiments for the insert used in the sprinkler-head adapter. FIG. 7a shows an insert 65a with three distinct segments: an exterior segment 66; a middle segment 68; and an interior segment 70. The segments 66, 68, and 70 are separated from each other by grooves that are formed in the segment body. In alternative embodiments, the number of segments could be varied. As shown in FIG. 5, both the middle segment 68 and the interior segment 70 are completely enclosed in the CPVC receptor. The exterior segment 66 is partially external to the receptor. In alternative embodiments, the amount of exposure of the exterior segment may vary. The surfaces of the segments can be adapted to help the insert stay positioned with the CPVC receptor. The surfaces of such segments would help the insert stay fixed in place and avoid spinning or a “pull-out” separation from the receptor. FIG. 7a shows an insert 65a with unmodified smooth surfaces on each segment. FIG. 7b shows an insert 65b with a middle segment 68 that has a “knurled” surface 72. The knurling is a cross-hatch pattern of small indentions that help the segment grip the receptor. FIG. 7c shows an octagonal shaped nut 74 on each of the three segments 66, 68, 70 of the insert 65c. As with the knurled surface, the octagonal shaped nut 74 will help hold the insert in place. In should be understood, that many variations and combinations can be made to the embodiments shown here. For example, some, none, or all of the segments may be altered to help the insert stay in place. Additionally, the shaped of the alterations can be varied as well. For example, a hexagonal shaped nut can be used in the same manner as an octagonal shape. Finally, the different techniques of modification may be mixed on different segments of the same insert.

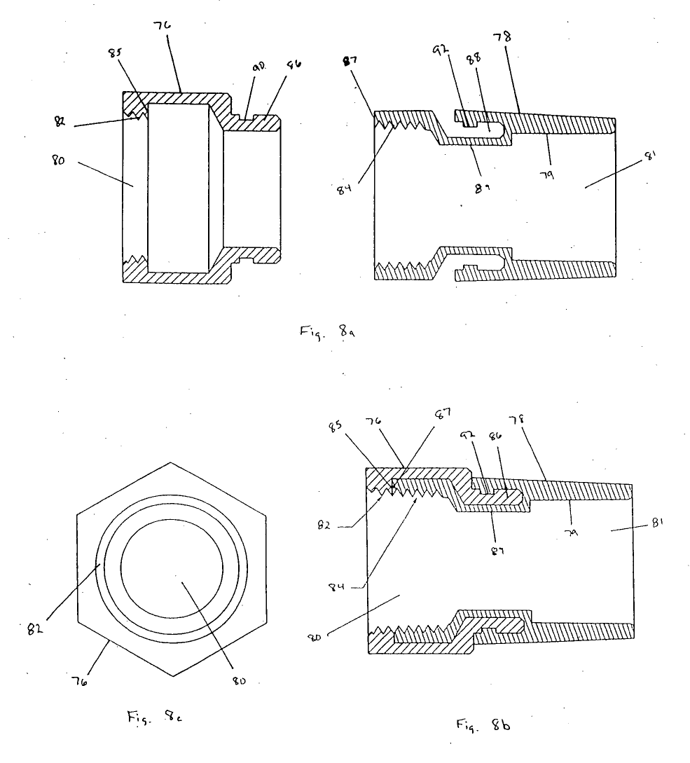

FIG. 8a shows an exploded view of an adapter with dual material threads in accordance with one embodiment of the present invention. FIG. 8b shows a cross-sectional view of the same embodiment as shown in FIG. 8a. FIG. 8c shows the embodiment from a frontal view. As shown in FIG. 8a, the adapter includes two segments: a guide insert 76 that is made of a rigid material such as brass; and a receptor 78 that is made of a plastic material such as CPVC. The guide insert 76 has an opening 80 that receives a threaded male pipe segment. The term threaded male pipe segment encompasses many different types of devices that may be connected to the adapter such as a sprinkler head for a fire suppression system or a water supply line. The only commonality is that each device has a male threaded segment that joins with the guide insert 76. Fluid is allowed to pass through the body of the adapter and out an opening 81 in the receptor 78. The receptor 78 has a socket 79 that connects to non-threaded male pipe segment as described previously. The non-threaded male pipe segment is inserted into the socket and glued in place to form a seal.

The guide insert 76 and receptor 78 are held together by an annular ring 92 that is formed around the interior of the receptor 78. The ring 92 fits into a recessed groove 90 that is formed on a connecting segment 86 of the insert 76. The connecting segment 86 is formed to fit in an interior space 88 of the receptor 78. The receptor 78 forms a protective layer 89 of CPVC around the interior of the insert 76 in such a manner as to provide a protected fluidway through the interior of the adaptor. The protected fluidway protects the insert from corrosion and also protects the contents of the fluidway from contamination from leaching, including lead or heavy metal contamination.

When the insert 76 and the receptor 78 are joined together, the threads 82 and 84 of each segment fit together to make a smooth and continuous transition 85 and 87 from one material to the other. Since the insert 76 and its threads 82 are made of brass in this example, they are more durable and there is less potential for cross-threading from the inserted male pipe segment. The brass threads 82 of the insert are numerous enough to ensure that the inserted male pipe segment is correctly aligned in the adaptor before it transitions to the CPVC threads 84 of the receptor 78. Plastic threads have the advantage of more easily forming a seal with the male pipe segment. The plastic materials are softer and more pliable than brass and consequently plastic forms a better seal if the threads of the adapter and pipe segment are properly aligned. Supplemental sealing materials such as tenon pipe tape or pipe filler material (i.e., pipe dope) may also be used to obtain a proper seal.

Once the male pipe segment makes the transition from brass to CPVC and seals against the CPVC threads, the entire interior of the brass receptor is insulated from exposure to the fluidway by the protective layer 89 of CPVC since the male pipe segment extends into the adaptor past the transition point of the two materials. The protective layer 89 of CPVC covers the entire interior surface of the insert 76 except for the threads 82 that serve to guide the male pipe segment into the receptor and also protect against rupture due to hoop stress. As shown in FIG. 8c, the insert 76 has flat surfaces on the exterior of the receptor in the form of a hexagonal shaped nut. The nut is used to grip the adapter while tightening the male pipe segment into the insert 76.

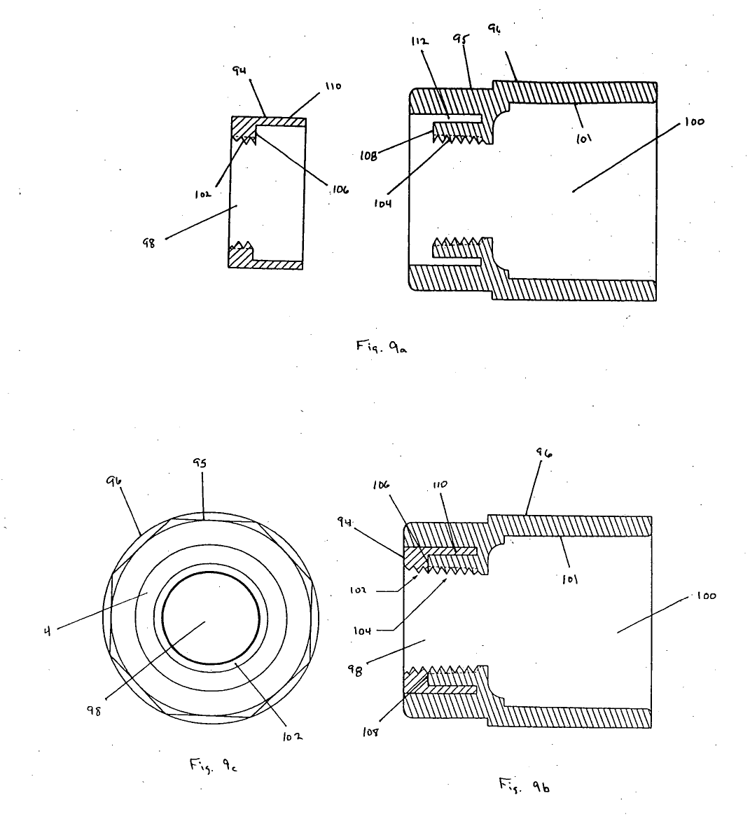

FIG. 9a shows an exploded view of a sprinkler-head adapter with dual material threads in accordance with an alternative embodiment of the present invention. It is intended for use with a sprinkler head described previously and shown in FIGS. 6a and 6b. FIG. 9b shows a cross section view of a sprinkler-head adapter with dual material threads of the same embodiment as shown in FIG. 9a. FIG. 9c shows the embodiment from a frontal view. In this example, the sprinkler-head adapter includes: a guide insert 94 that is made of a rigid material such as brass; and a receptor 96 that is made of a plastic material such as CPVC. The guide insert 94 has an opening 98 that receives a threaded male pipe segment. Fluid is allowed to pass through the body of the adapter and out an opening 100 in the receptor 96. The receptor 96 has a socket 101 that connects to non-threaded male pipe segment as previously described. The non-threaded male pipe segment is inserted into the socket and glued in place to form a seal. The receptor 96 is formed around the guide insert 94. The insert 94 may be held in place by “knurling” as previous shown and described in FIGS. 7a-7c to prevent spinning and/or separation of the two components of the sprinkler-head adapter.

As previously discussed in the embodiment shown in FIGS. 8a-8c, when the insert 94 and the receptor 96 are joined together, the threads of each segment 102 and 104 fit together to make a smooth and continuous transition from one material to the other. Since the insert 94 and its threads 102 are made of brass in this example, they are more durable and there is less potential for cross-threading from the inserted male pipe segment. The brass threads 102 of the insert are numerous enough to ensure that the inserted male pipe segment is correctly aligned in the adaptor before it transitions to the CPVC threads 104 of the receptor 96. Once the male pipe segment makes the transition from brass to CPVC, the entire interior of the brass receptor is insulated from exposure to the fluidway by the protective layer of CPVC since the male pipe segment extends into the adaptor past the transition point of the two materials. The protective layer of CPVC covers the entire interior surface of the insert 94 except for the threads 102 that serve to guide the male pipe segment into the receptor and also protect against rupture due to hoop stress. As shown in FIG. 9c, the receptor 96 has flat surfaces 95 on the exterior of the receptor in the form of an octagonal shaped nut. The flat surfaces 95 are used to grip the adapter while tightening the male pipe segment into the insert 94.

While FIGS. 8a-8c and FIGS. 9a-9c and their accompanying descriptions show two different embodiments of the present invention, it should understood that the present invention may be configured in accordance with multiple combinations of the features described previously. For example, variations in materials, pipe size, form/pitch/taper of pipe threads, exterior shape, etc. should be considered as different embodiments.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A female pipe adapter comprising:
a rigid guide insert and a receptor for aligned connection with one another for fluid flow therethrough,
the rigid guide insert having a first toothed connecting portion and the receptor having a toothed receiving area with a collar and dual walls defining a space for receiving and fully enclosing the first connecting portion of the rigid guide insert to prevent exposure of the first connecting portion of the rigid guide insert to the fluid flow, the rigid guide insert having a second connecting portion which is internally threaded for female connection with another pipe component.

2. A pipe adapter, comprising:
a rigid metal guide insert having a main body with a first end that is internally threaded for receiving a male pipe and a second narrowed end forming a neck portion; and
a plastic receptor having a main body with a first end that is connectable to a pipe segment and a second end having a collar with dual walls defining a space for receiving the neck portion of the metal guide insert;
wherein the inner wall of the collar abuts the threads of the first end of the metal guide insert, the metal guide insert being fully shielded from fluid flow.

3. A pipe adapter of claim 2, wherein the inner wall of the plastic receptor includes a plurality of internal threads matching the threads of the first end of the metal guide insert so that the male pipe segment threads into both the metal guide insert and the plastic receptor.

4. A pipe adapter of claim 3, wherein the plastic receptor is formed around the metal guide insert.
